(19) United States
(12) Patent Application Publication
(10) Pub. No.: US 2017/0050319 A1
(43) Pub. Date: Feb. 23, 2017

(54) Programmable Machine Vision Device

(71) Applicants: Tyco Electronics (Shanghai) Co. Ltd., Shanghai (CN); Tyco Electronics Corporation, Berwyn, PA (US)

(72) Inventors: Lei Zhou, Shanghai (CN); Dandan Zhang, Shanghai (CN); Roberto Francisco-Yi Lu, Berwyn, PA (US)

(73) Assignees: Tyco Electronics (Shanghai) Co. Ltd., Shanghai (CN); Tyco Electronics Corporation, Berwyn, PA (US)

(21) Appl. No.: 15/239,135

(22) Filed: Aug. 17, 2016

(30) Foreign Application Priority Data
Aug. 18, 2015 (CN) 201510507661.8

(51) Int. Cl. B25J 9/16; H04N 5/225; G06T 7/60; H04N 5/232; G06K 9/00; G06T 7/00

(52) U.S. Cl. CPC B25J 9/1697; G06K 9/00671; G06T 7/0004; G06T 7/60; H04N 5/23203; H04N 5/23216; H04N 5/23293; H04N 5/2256; G06K 2209/01; G06T 2207/20092; G06T 2207/30108; Y10S 901/47

(57) ABSTRACT

A programmable machine vision device includes: an I/O (input/output) layer adapted to connect with various cameras, controllers of various external executing mechanisms and various databases; an algorithm and control layer adapted to process images captured by various cameras and perform an internal logic control; and a GUI (graphic user interface) layer through which a user interacts with the programmable machine vision device. The algorithm and control layer receives the image captured by the camera through the I/O layer, processes and analyzes the received image, makes a judgment, and sends processing, analyzing and judging results to the controller of the external executing mechanism, so as to control the external executing mechanism to execute various machine vision tasks. The programmable machine vision device is adapted to various different brands of cameras, controllers of various different brands of external executing mechanisms, and various different kinds of databases and has good commonality.

### CROSS-REFERENCE TO RELATED APPLICATION

This application claims the benefit of the filing date under 35 U.S.C. §119(a)-(d) of Chinese Patent Application No. 201510507661.8 filed on Aug. 18, 2015.

### FIELD OF THE INVENTION

The present invention relates to a programmable machine vision device.

### BACKGROUND

Machine vision technology is a key technology for an automatic production line. By use of the machine vision technology, it may improve the manufacturing precision and flexibility of the automatic production line, reduce the material cost and labor cost, and simplify the design of the mechanical system of the automatic production line.

Machine vision applications may comprise: target location, visual guidance, size measurement, and appearance detection. Many machine vision applications have the same visual function. For example, for an operation of picking up and installing a work piece based on visual guidance, it needs to develop a variety of machine vision devices suitable for various kinds of robots and various kinds of cameras. Although image processing algorithms for the same operation are the same, if a new different brand of camera or a new different brand of robot is used, it still needs to redevelop a set of machine vision device suitable for the new brand of camera or the new brand of robot. Engineers will have to spend a lot of time doing repetitive and boring works, which is really a waste of resources.

### SUMMARY

The present invention has been made to overcome or alleviate at least one aspect of the above mentioned disadvantages.

According to the present invention, there is provided a programmable machine vision device with good commonality, which is adapted to various different brands of cameras, controllers of various different brands of external executing mechanisms, and various different kinds of databases.

According to an aspect of the present invention, there is provided a programmable machine vision device, comprising: an I/O (input/output) layer adapted to be connected with various cameras, controllers of various external executing mechanisms and various databases; an algorithm and control layer adapted to process images captured by various cameras and perform an internal logic control; and a GUI (graphic user interface) layer through which an user interacts with the programmable machine vision device. The algorithm and control layer is further configured to receive the image captured by the camera through the I/O layer, process and analyze the received image, make a judgment based on the received image, and send processing, analyzing and judging results to the controller of the external executing mechanism, so as to control the external executing mechanism to execute various machine vision tasks.

In an exemplary embodiment of the present invention, the I/O layer comprises: a camera interface adapted to be connected with the various cameras; a communication interface adapted to be connected with the controllers of various external executing mechanisms; and a database interface adapted to be connected with the various databases.

In another exemplary embodiment of the present invention, the camera interface comprises at least one of GenICam GenTL Standard, GigE, IIDC 1394, DirectX, OpenNI, TWAIN, USB3.0, CameraLink, and Frame Grabbers; and the communication interface comprises TCP and/or UDP; the database interface comprises at least one of ACCESS, ORACLE, and SQL.

In another exemplary embodiment of the present invention, the controller of the external executing mechanism comprises a PLC controller and a ROBOT controller, and the programmable machine vision device is communicated with the PLC controller and the ROBOT controller through the TCP/UDP communication interface.

In another exemplary embodiment of the present invention, operator information, operation status, and alarm information are recorded in the database.

In another exemplary embodiment of the present invention, the algorithm and control layer comprises: an image processing module adapted to build up an image data structure and an image processing algorithm corresponding to the image data structure; and a logic control module driven by internal messages and used to perform the internal logic control.

In another exemplary embodiment of the present invention, the image processing algorithm is configured to perform coordinate calibration, size measurement, appearance detection, and character recognition; and the logic control module configured to perform a camera control, a lighting control, a status control, and a process control.

In another exemplary embodiment of the present invention, the GUI layer comprises of: an image display module used to display the captured image, connection status of the controller of the external executing mechanism, and information of the connected camera; a result display module used to display the processing, analyzing and judging results of the image; a setting module used to set the camera, the communication interface, a light source, and a user access authority; and an interactive operation module through which the user inputs various operation instructions to the programmable machine vision device.

In another exemplary embodiment of the present invention, the setting module is adapted to set processing algorithm, triggering time, triggering mode, gain, exposure, interface type, and image storage of the camera.

In the above various exemplary embodiments of the present invention, the I/O layer of the programmable machine vision device is adapted to connect various cameras, controllers of various external executing mechanisms and various databases. Thereby, the programmable machine vision device has good commonality and may be used to various different brands of cameras, various different brands of external executing mechanisms, and various different types of databases. In this way, engineers may focus on the development of image processing algorithms, and may not need to develop repetitive and boring interface programs. In addition, the developed image processing algorithm may be packaged in storage and it may shorten the development cycle, greatly save the time cost, and reduce the labor costs for developing the programmable machine vision device.

In the above various exemplary embodiments of the present invention, the algorithm and control layer receives the image captured by the camera through the I/O layer, processes and analyzes the received image and makes a judgment, and sends processing, analyzing and judging results to the controller of the external executing mechanism, so as to control the external executing mechanism to execute various machine vision tasks.

### BRIEF DESCRIPTION OF THE DRAWINGS

The above and other features of the present invention will become more apparent by describing in detail exemplary embodiments thereof with reference to the accompanying drawings, in which:

FIG. 1 is an illustrative function block diagram of a programmable machine vision device according to an exemplary embodiment of the present invention.

### DETAILED DESCRIPTION OF THE EMBODIMENT(S)

Exemplary embodiments of the present disclosure will be described hereinafter in detail with reference to the attached drawing, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the invention to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided a programmable machine vision device, comprising: an I/O (input/output) layer adapted to be connected with various cameras, controllers of various external executing mechanisms and various databases; an algorithm and control layer adapted to process images captured by various cameras and perform an internal logic control; and a GUI (graphic user interface) layer through which a user interacts with the programmable machine vision device. The algorithm and control layer is further configured to receive the image captured by the camera through the I/O layer, process and analyze the received image, make a judgment, and send processing, analyzing and judging results to the controller of the external executing mechanism, so as to control the external executing mechanism to execute various machine vision tasks.

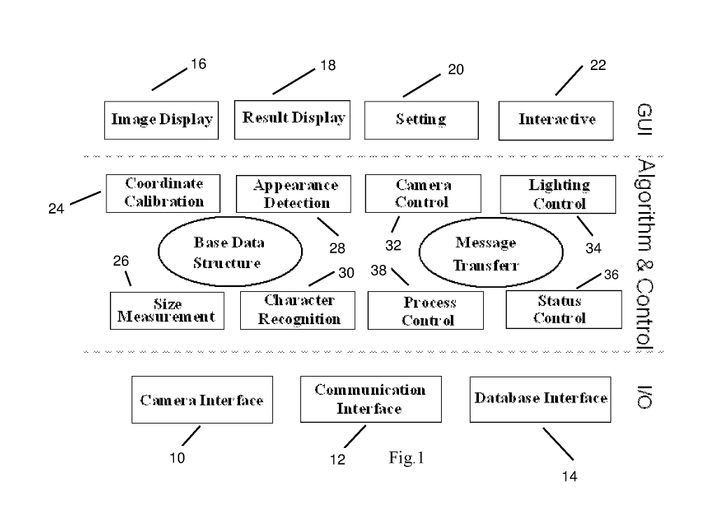

FIG. 1 is an illustrative function block diagram of a programmable machine vision device according to an exemplary embodiment of the present invention.

As shown in FIG. 1, the programmable machine vision device mainly comprises an I/O (input/output) layer, an algorithm and control layer, and a GUI (graphic user interface) layer.

As shown in FIG. 1, in an embodiment, the I/O (input/output) layer is adapted to be connected with various cameras, controllers of various external executing mechanisms and various databases. The algorithm and control layer is adapted to process images captured by various cameras and perform an internal logic control. A user may interact with the programmable machine vision device through the GUI (graphic user interface) layer.

As shown in FIG. 1, in an embodiment, the algorithm and control layer is configured to receive the image captured by the camera through the I/O layer, then process and analyze the received image, and make a judgment based one the received image. Then, processing, analyzing and judging results are sent to the controller of the external executing mechanism through the I/O (input/output) layer, so as to control the external executing mechanism to execute various machine vision tasks.

As shown in FIG. 1, in an embodiment, the I/O layer mainly comprises: a camera interface 10 adapted to be connected with the various different types of cameras; a communication interface 12, adapted to be connected with the controllers of various different types of external executing mechanisms; and a database interface 14 adapted to be connected with the various different types of databases.

In an embodiment of the present invention, the camera interface 10 may comprise at least one of GenICam GenTL Standard, GigE, IIDC 1394, DirectX, OpenNI, TWAIN, USB3.0, CameraLink, and Frame Grabbers.

In an embodiment of the present invention, the communication interface 12 may comprise TCP and/or UDP.

In an embodiment of the present invention, the database interface 14 may comprise at least one of ACCESS, ORACLE, and SQL.

In an embodiment of the present invention, the controller of the external executing mechanism may comprise a PLC controller and a ROBOT controller. The programmable machine vision device may be communicated with the PLC controller and the ROBOT controller through the TCP/UDP communication interface.

In an embodiment of the present invention, operator information, operation status, and alarm information may be recorded in the database.

As shown in FIG. 1, in an embodiment, the algorithm and control layer mainly comprises: an image processing module adapted to build up an image data structure and an image processing algorithm corresponding to the image data structure; and a logic control module driven by internal messages and used to perform internal logic control.

Referring to FIG. 1 again, in an embodiment, the image processing algorithm is configured to perform coordinate calibration 24 (for example, camera coordinate calibration, and work piece coordinate calibration), size measurement 26 (for example, work piece size measurement), appearance detection 28 (for example, recognition of work piece appearance features), and character recognition 30 (for example, recognition of character on work piece).

As shown in FIG. 1, in an embodiment, the logic control module may be configured to perform a camera control 32, a lighting control 34, a status control 36, and a process control 38.

As shown in FIG. 1, in an embodiment, the GUI layer mainly comprises: an image display module 16 configured to display the captured image, connection status of the controller of the external executing mechanism, and information of the connected camera; a result display module 18 configured to display the processing, analyzing and judging results of the image; a setting module 20 configured to set the camera, the communication interface 12, a light source, and a user access authority; and an interactive operation module 22 through which the user inputs various operation instructions to the programmable machine vision device.

As shown in FIG. 1, in an embodiment, the setting module 20 is adapted to set processing algorithm, triggering time, triggering mode, gain, exposure, interface type, and image storage of the camera.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it will be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A programmable machine vision device, comprising:
an I/O (input/output) layer adapted to be connected with various cameras, controllers of various external executing mechanisms and various databases;
an algorithm and control layer:
(a) adapted to:
(1) process images captured by various cameras, and
(2) perform an internal logic control, and
(b) configured to
(1) receive the image captured by the camera through the I/O layer,
(2) process and analyze the received image,
(3) make a judgment based on the received image, and
(4) send processing, analyzing and judging results to the controller of the external executing mechanism, so as to control the external executing mechanism to execute various machine vision tasks;
a GUI (graphic user interface) layer through which a user interacts with the programmable machine vision device;
an algorithm and control layer adapted to process images captured by various cameras and perform an internal logic control; and
a GUI (graphic user interface) layer through which a user interacts with the programmable machine vision device,

2. The programmable machine vision device according to claim 1, wherein the I/O layer comprises:
(a) a camera interface adapted to be connected with the various cameras,
(b) a communication interface adapted to be connected with the controllers of various external executing mechanisms, and
(c) a database interface adapted to be connected with the various databases.

3. The programmable machine vision device according to claim 2, wherein:
(a) the camera interface comprises at least one of GenICam GenTL Standard, GigE, IIDC 1394, DirectX, OpenNI, TWAIN, USB3.0, CameraLink, and Frame Grabbers;
(b) the communication interface comprises TCP and/or UDP, and
(c) the database interface comprises at least one of ACCESS, ORACLE, and SQL.

4. The programmable machine vision device according to claim 3, wherein:
(a) the controller of the external executing mechanism comprises a PLC controller and a ROBOT controller, and
(b) the programmable machine vision device is communicated with the PLC controller and the ROBOT controller through the TCP/UDP communication interface.

5. The programmable machine vision device according to claim 3, wherein operator information, operation status, and alarm information are recorded in the database.

6. The programmable machine vision device according to claim 2, wherein the algorithm and control layer comprises:
(a) an image processing module adapted to build up an image data structure and an image processing algorithm corresponding to the image data structure, and
(b) a logic control module driven by internal messages and configured to perform the internal logic control.

7. The programmable machine vision device according to claim 6, wherein:
(a) the image processing algorithm is configured to perform coordinate calibration, size measurement, appearance detection, and character recognition, and
(b) the logic control module is configured to perform a camera control, a lighting control, a status control, and a process control.

8. The programmable machine vision device according to claim 6, wherein the GUI layer comprises:
(a) an image display module configured to display the captured image, connection status of the controller of the external executing mechanism, and information of the connected camera,
(b) a result display module configured to display the processing, analyzing and judging results of the image,
(c) a setting module configured to set the camera, the communication interface, an light source, and an user access authority, and
(d) an interactive operation module through which the user inputs various operation instructions to the programmable machine vision device.

9. The programmable machine vision device according to claim 8, wherein the setting module is adapted to set processing algorithm, triggering time, triggering mode, gain, exposure, interface type, and image storage of the camera.
